(19) United States
(12) Patent Application Publication
(10) Pub. No.: US 2010/0235855 A1
(43) Pub. Date: Sep. 16, 2010

(54) RECEIVING SYSTEM AND METHOD THEREOF

(76) Inventors: Jen-Chieh LO, Tai Pei County (TW); Yung-Hsiang Lin, Chang Hua City (TW)

Correspondence Address: Muncy, Geissler, Olds & Lowe, PLLC, 4000 Legato Road, Suite 310, FAIRFAX, VA, 22033, US

(21) Appl. No.: 12/709,170

(22) Filed: Feb. 19, 2010

(30) Foreign Application Priority Data
Mar. 10, 2009 (TW) 098107715

(51) Int. Cl. H04N 7/16

(52) U.S. Cl. 725/25

(57) ABSTRACT

A representative receiving system is disclosed. The receiving system has sifting functions. The receiving system includes a receiving unit, a processing unit, a storing unit, a user interface and a determining unit. The receiving system uses the storing unit to store a plurality of rating region tables, and provides functions of editing the rating region tables for users.

### BACKGROUND

(a) Technical Field

The invention relates to a receiving system.

(b) Description of the Related Art

As shown in FIG. 1, the frame of a receiving system 10 of a display device in the prior art is used to provide parents with the setting functions and control mechanisms to allow or lock TV programs. Thus, parents can keep inappropriate programs, such as violent or erotic programs, away from children or teenagers. As shown in the figure, according to the rating table 11 provided by the channel, the conventional receiving system 10 divides programs into a plurality of levels: such as TV-Y (entire audience), TV-Y7 (children above 7 years of age), TVG (children between 7 years and 14 years of age), TV-PG (younger children with parental guidance), TV-14 (children above 14 years of age), TV-MA (adult only). The receiving system 10 also provides parents with a plurality of options: ALL (entire audience), FV (fantasy violence), V (violence), S (sex), L (coarse language), D (suggestive dialogue). Each level is used to describe suitable viewing age groups. However, there are different rating tables and different rating systems for distinctive countries, regions, or television stations. For example, as the channels for two different TV stations have two different rating tables and different rating systems, the conventional receiving system has to reprocess the rating table and rating data of all receiving channels while receiving channel signals each time. Thus, there are problems such as higher power consumption, more operating inconveniences, and lower system processing speed.

### BRIEF SUMMARY

One objective is to provide a receiving system (parental control system) for storing a plurality of rating tables without repeatedly reprocessing different rating tables or different rating systems to thereby reduce power consumption or raise the system processing speed.

One objective is to provide a user interface for a receiving system to provide a user to edit a rating table and the data in the table.

### BRIEF DESCRIPTION OF THE DRAWINGS

FIG. 1 shows a schematic diagram illustrating the frame of a receiving system in the prior art.

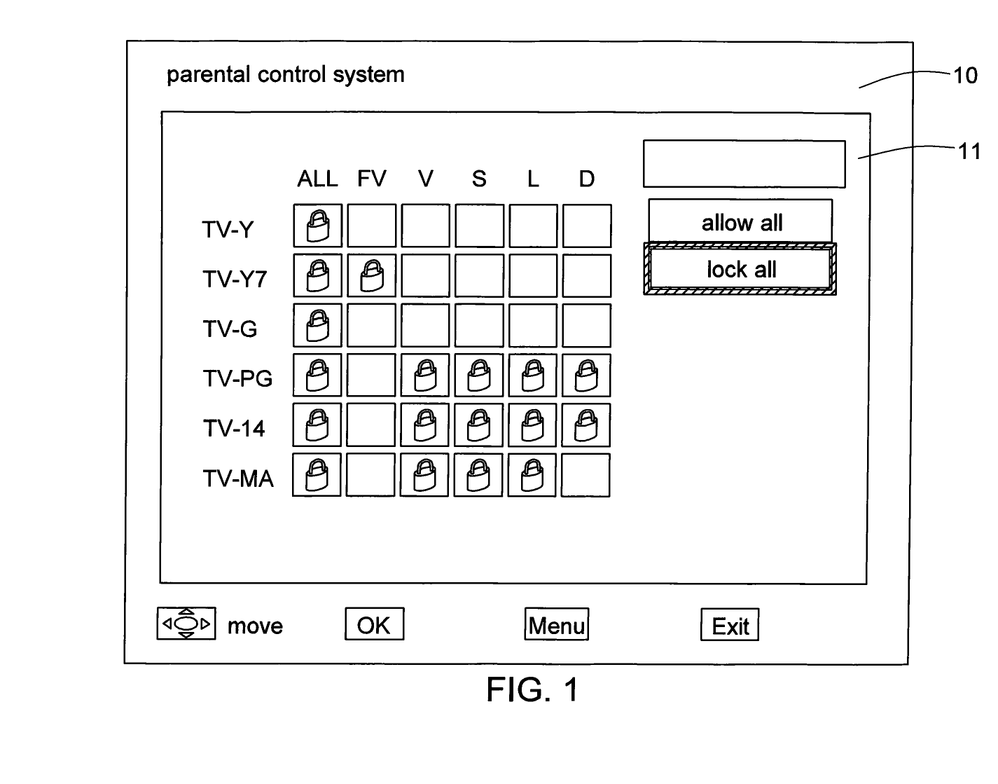

FIG. 2A shows a schematic diagram illustrating a receiving system of an embodiment.

FIG. 2B shows a schematic diagram illustrating a rating table of the receiving system shown in FIG. 2A of an embodiment.

FIG. 2C shows a schematic diagram illustrating each rating table of the receiving system shown in FIG. 2A of an embodiment.

FIG. 2D shows a schematic diagram illustrating one menu of the rating table of the receiving system shown in FIG. 2A of an embodiment.

FIG. 3A shows a flow chart illustrating a setting method for filtering TV programs of an embodiment.

FIG. 3B shows a schematic diagram illustrating one menu of the rating table of the receiving system of an embodiment.

### DETAILED DESCRIPTION

With reference to the accompanying figures, the following describes the receiving system (parental control system), data sifting method and user interface according to the invention. Besides, the same elements are denoted by the same symbols.

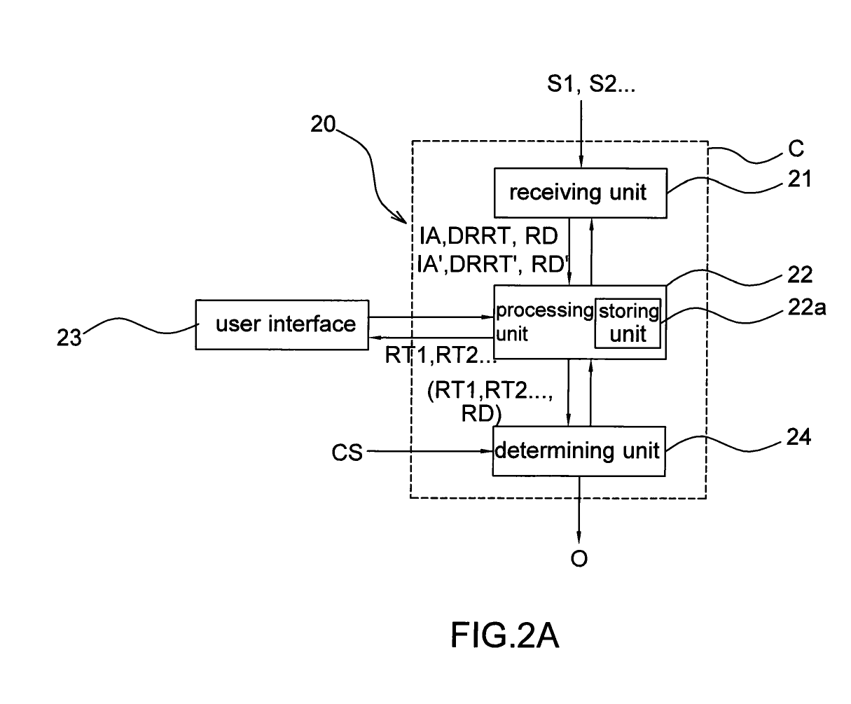

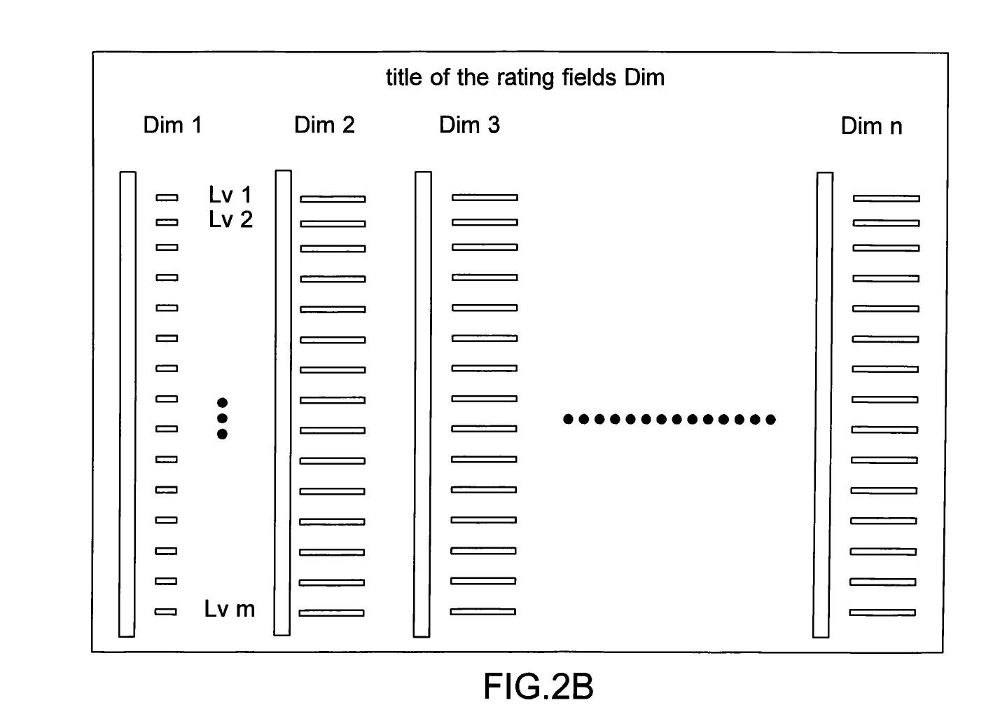

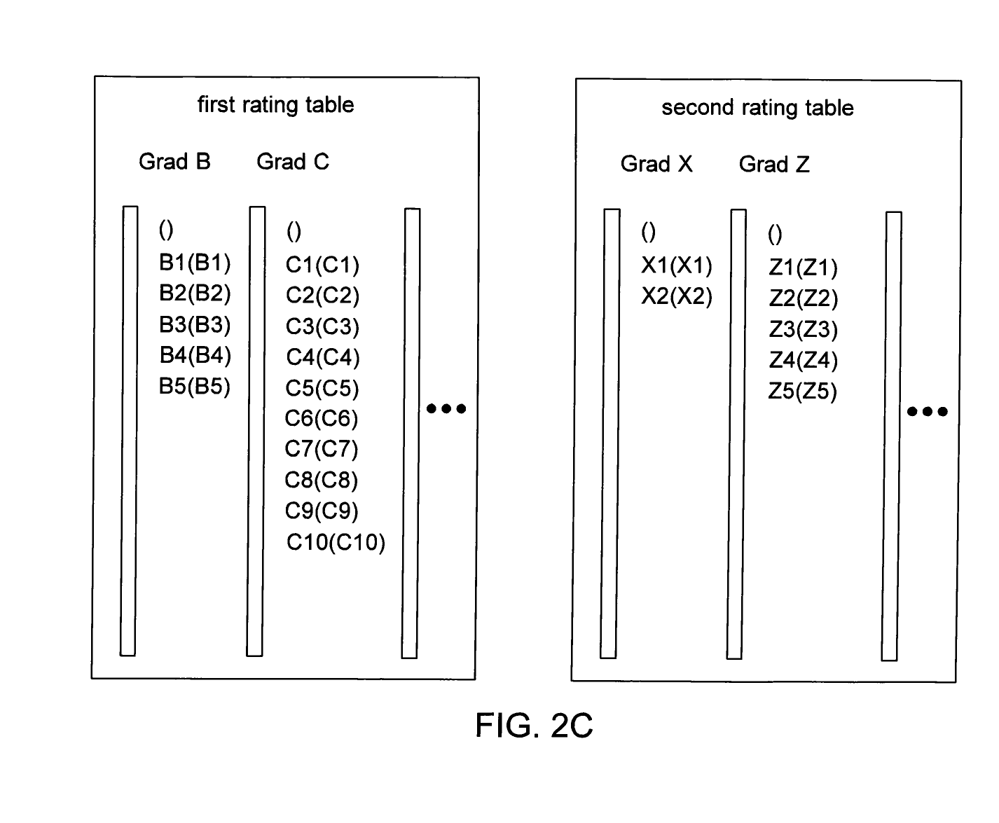

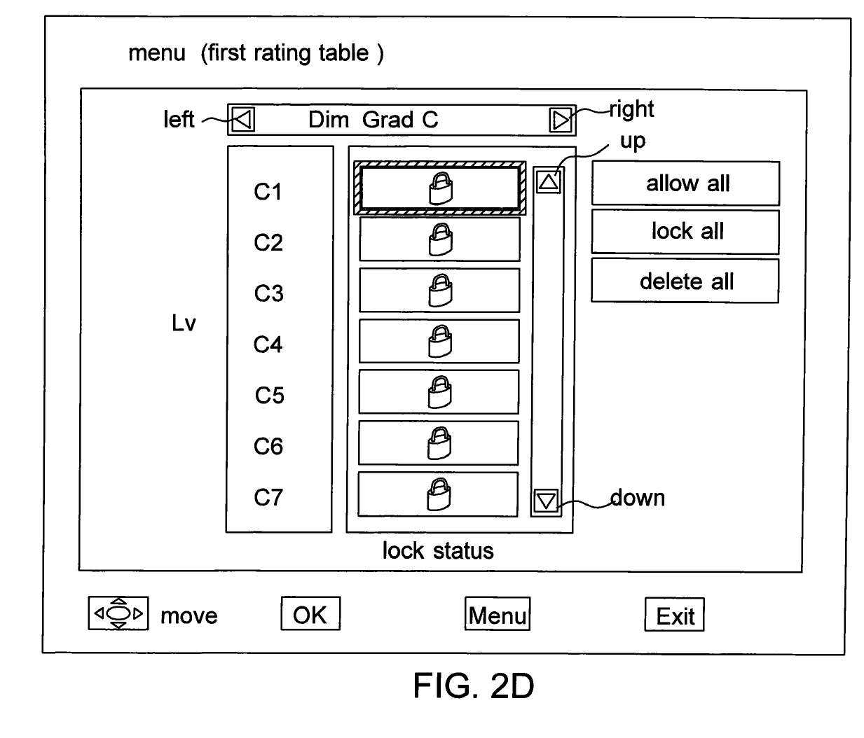

FIG. 2A shows a schematic diagram illustrating a receiving system 20 of an embodiment. The receiving system 20 can be applied to any current or future display device. The receiving system 20 comprises a control unit C, a user interface 23, and a storing unit 22a. The control unit C comprises a receiving unit 21, a processing unit 22, and a determining unit 24. In one embodiment, the storing unit 22a is provided in the processing unit 22 while, in another embodiment, the storing unit 22a is provided outside the processing unit 22 and is an external storing unit, instead.

The receiving unit 21 can receive one or more than one channel signals for detecting and collecting the data provided by the signals of the channels. In one embodiment, the receiving unit 21 can receive at least two channel signals separately or simultaneously, such as a first signal S1 and a second signal S2. The first signal S1 comprises at least two items selected from the group consisting of the following: a first video/audio signal IA corresponding to the channel of the first signal S1, a first downloadable rating region table (DRRT), and a first rating data (RD). The second signal S2 comprises at least two items selected from the group consisting of the following: a second video/audio signal IA′ corresponding to the channel of the second signal S2, a second downloadable rating region table (DRRT′), and a second rating data (RD′).

The processing unit 22 is to process at least one rating region table DRRT and at least one rating data RD. In one embodiment, the processing unit 22 is a downloadable rating region table (DRRT) handler. In another embodiment, the processing unit 22 processes the first signal S1 according to at least one of the first rating data (RD) and the first downloadable rating region table (DRRT) and processes the second signal S2 according to at least one of the second rating data (RD′) and the second downloadable rating region table (DRRT′). Thus, the processing unit 22 generates a first rating table RT1 and a second rating table RT2 corresponding to the first signal S1 and the second signal S2, respectively. The first rating table RT1 and the second rating table RT2 each comprise a plurality of rating fields Dim 1˜Dim n (n is a positive integer) and each rating field Dim comprises a plurality of rating levels Lv 1˜Lv m (m is a positive integer) (rating fields Dim and rating levels Lv are shown in FIG. 2B).

It should be noted that the processing unit 22 of one embodiment comprises at least one storing unit 22a. The storing unit 22a is provided with a plurality of table entries for storing a plurality of rating tables RT1, RT2 . . . , etc.

The user interface (UI) 23 is to provide a user with a operating interface to set up the program filtering method or program rating of the receiving system 20. In one embodiment, the user interface 23 provides a user to set at least one of the rating fields Dim 1˜Dim n and at least one of the rating levels Lv 1˜Lv m in the first rating table RT1 and the second rating table RT2. It should be noted that the user interface 23 also provides a user to edit the titles or the number of the rating fields Dim 1˜Dim n in the first rating table RT1 and the second rating table RT2 and edit the titles or the number of the rating levels Lv 1˜Lv m in the first rating table RT1 and the second rating table RT2. In addition, the user interface 23 also provides a user to add or delete a rating table.

It should be noted that the format of the rating table of one embodiment can be defined or standardized according to a preset television station, a preset region, or a preset country. In one embodiment, as shown in FIG. 2B, the rating tables RT1, RT2 comprise a plurality of rating fields Dim 1˜Dim n and each rating field Dim comprises a plurality of rating levels Lv 1˜Lv m. A user can set at least one of the rating fields Dim 1˜Dim n and at least one of the rating levels Lv 1˜Lv m corresponding to the rating table of the channel. Besides, in one embodiment, the user interface 23 has various editing functions for a user to edit the titles and the number of the rating fields Dim and edit the titles and the number of the rating levels Lv. In another embodiment, the user interface 23 has the function of editing a rating table so that a user can add or delete the rating table.

It should be noted that, in one embodiment, different rating fields Dim of different rating tables RT can be correlated. For example, Dim 1 of the first rating table RT1 is defined as the “Violence” field while Dim 1 of the second rating table RT2 is also defined as the “Violence” field. As Dim 1 of the first rating table RT1 is set to be locked for all rating levels Lv, Dim 1 of the second rating table RT2 will be automatically locked for all rating levels Lv due to the correlation design. In another embodiment, the same rating levels of the same rating field of different rating tables can be correlated. For example, Dim 2 of the first rating table RT1 is defined as the “Sex” field while Dim 2 of the second rating table RT2 is also defined as the “Sex” field. As the rating level Lv 5 of Dim 2 of the first rating table RT1 is set to be locked, the rating level Lv 5 of Dim 2 of the second rating table RT2 will be automatically locked due to the correlation design. In another embodiment, the plurality of rating levels of each rating field Dim can be set to have predetermined order. For example, it is assumed that the rating field Dim 1 of the first rating table RT1 is defined as the “Violence” field and has four rating levels. Each rating level is differentiated by age. Lv 1 is for children under 6 years of age, Lv 2 is for children between 7˜12 years of age, Lv 3 is for teenagers between 13˜18 years of age, and Lv 4 is for adult above 19 years of age. As Lv 3 is set to be locked, Lv 1 and Lv 2 are automatically set to be locked due to the age under 13 (according to the order). In another embodiment, the same rating fields Dim of different rating tables RT or the same level Lv of the same rating fields Dim of different rating tables RT may be set to be not correlated and also different levels Lv of each rating field Dim may be set to have no order.

The determining unit 24 determines how to output the signal S to the display device according to the parameters provided by the rating table RT set by the user via the user interface 23 and the rating data of the input signal S. In one embodiment, the determining unit 24 is a violent-chip judger. In another embodiment, the determining unit 24 determines whether or not to output the first video/audio signal IA and the second video/audio signal IA′ via the output signal O to be displayed on a display device according to a channel selection signal CS, the first rating table RT1, and the second rating table RT2. In one embodiment, as the formats of the rating tables RT1, RT2, . . . of the signals S1, S2, . . . are all the same, the determining unit 24 uses the same rating table RT to determine. For example, as the formats of the rating tables RT1 and RT2 are the same, the determining unit 24 uses RT2 to determine the signals S1, S2. In another embodiment, the determining unit 24 selects the least used, the oldest, or the random rating table among the first rating table RT1 or the second rating table RT2 to determine the first signal S1 and the second signal S2, as the format of the first rating table RT1 is the same as that of the second rating table RT2.

The following further describes the operating principle of the receiving system 20 of one embodiment with reference to FIG. 2A and FIG. 2C.

It is assumed that the first signal S1 comprises the video/audio signal IA, the rating region table DRRT1, and the rating data RD1. The rating region table DRRT1 and the rating data RD1 correspond to the first rating table RT1 on the left-hand side of FIG. 2C and the first rating table RT1 complies with the specification of the first TV station. The second signal S2 comprises the video/audio signal IA′, the rating region table DRRT2 and the rating data RD2. The rating region table DRRT2 and the rating data RD2 correspond to the second rating table RT2 on the right-hand side of FIG. 2C and the second rating table RT2 complies with the specification of the second TV station. Besides, it is assumed that the table entries of the storing unit 22a of the processing unit 22 is preset to store 5 rating tables and, before detecting the signals S1, S2, the storing unit 22a has stored 3 rating tables: the rating table RT3 of the third signal S3, the rating table RT4 of the fourth signal S4, and the rating table RT5 of the fifth signal S5. The fifth signal S5 belongs to the second TV station. The rating table RT5 and rating table RT2 have the same specification.

At first, the receiving unit 21 receives and detects the data of the first signal S1 and processes and/or analyzes the first signal S1 to determine whether the rating region table DRRT1 is acquired or not. If the rating region table DRRT1 is acquired, it is to be determined whether the rating region table DRRT1 of the current signal S1 needs updating or not. If updating is required, one access point (AP) of the display device is notified to update the rating region table DRRT1. If the rating region table DRRT1 is not acquired, the receiving unit 21 is notified to detect the first signal S1 again.

On the other hand, as the receiving unit 21 processes and/or analyzes the first signal S1, it determines whether the rating data RD1 is also acquired simultaneously or not. If the rating data RD1 is acquired, it is to be determined whether the rating data RD1 of the current first signal S1 is legal or not. If it is legal, one access point (AP) of the display device is notified that the rating data RD1 is legal. If the rating data RD1 is illegal, the receiving unit 21 detects the first signal S1 again. It should be noted that the way to detect the second signal S2 is the same as that for the first signal S1. Thus, the details will not be given hereafter.

Then, the processing unit 22 processes the rating region table DRRT1 and the rating data RD1 to generate a first rating table RT1.

It should be noted that the storing unit 22a of the processing unit 22 has stored three rating tables: RT3, RT4, and RT5, at this time. Then, the processing unit 22 compares the first rating table RT1 with the rating tables RT3, RT4, RT5 to find the specification difference between the first rating table RT1 and the rating tables RT3, RT4, RT5 to determine whether the first rating table RT1 is a new rating table or not. If it is determined that the first rating table RT1 is a new rating table, the processing unit 22 further determines whether the name of the new rating table RT1 is the same as those of the stored rating tables RT3, RT4, RT5. If it is the same, the first rating table RT1 is used to update the rating table stored in the storing unit 22a having the same name with the first rating table RT1 and also to be provided to the user interface 23. If it is different, while the storing unit 22a still has space, the storing unit 22a stores the first rating table RT1; and while the storing unit 22a has no space, the storing unit 22a selects the oldest, the least used, or the random rating table to be replaced with the first rating table RT1 and then the first rating table RT1 is provided to the user interface 23. Here, it is assumed that the name of the first rating table RT1 is different and the storing unit 22a still has space. Then, the storing unit 22a stores the first rating table RT1. Therefore, the storing unit 22a stores four rating tables: RT1, RT3, RT4, and RT5.

It should be noted that, as the second signal S2 is processed by the above method to generate a second rating table RT2, the processing unit 22 compares the second rating table RT2 with the stored rating tables RT1, RT3, RT4, RT5. Since RT2 and RT5 are preset to both belong to the second TV station, the second rating table RT2 is an old rating table (that is, the specification of RT2 is the same as that of RT5) and thus the processing unit 22 stops processing the second rating table RT2.

On the other hand, as the processing unit 22 receives each signal S, the rating data RD in the signal S will be compared with all the rating tables RT in the storing unit 22a to search for whether there is the rating table corresponding to the rating data RD or not. If not, it stops processing the rating data RD; if yes, the rating data RD is provided to the determining unit 24 for reference.

It should be noted that the data of each above rating table RT is displayed on a display device via the user interface 23 by the way shown in FIG. 2D. Then, the user can rate each program of each channel via the user interface 23. For example, it is assumed that the user is to set the field GradC of the first rating table in FIG. 2C. The user can use various functional options, such as “Left”, “Right”, “Up”, “Down”, “Move”, “OK”, “Manu”, “Exit”, “allow all”, “lock all”, and “delete all”, to set each level Lv (C1˜C7) of the field GradC. For example, allowing every level Lv (C1˜C7) is done by clicking the option “allow all”, locking every level Lv (C1˜C7) is done by clicking the option “lock all”, and deleting all the settings of every level Lv (C1˜C7) is done by clicking the option “delete all” for reset. Obviously, each level Lv (C1˜C7) can be set separately by clicking each setting for each level Lv (C1˜C7) to delete or lock each level Lv (C1˜C7). In one embodiment, the user can delete all the rating tables RT stored in the storing unit 22a via the user interface 23 and add a new rating tables RT. Therefore, the receiving system of an embodiment has great flexibility and convenience in practice. In one embodiment, when the option “Left” is clicked, it will go into the menu for the preceding field Dim; when the option “Right” is clicked, it will go into the menu for the next field Dim; when the option “Up” is clicked and the position exceeds that of the level C1, it will go into the preceding field Dim; when the option “Down” is clicked and the position exceeds that of the level C7, it will go into the next field Dim.

Finally, the determining unit 24 determines whether the video/audio signal IA is displayed on a display device via the output signal O or not according to the rating table RT of the signal S, the rating data RD of the signal S. and a channel selection signal CS. In one embodiment, the channel selection signal CS can be a signal inputted by a user via the user interface. In another embodiment, the channel selection signal CS can be a signal generated according to each rating field Dim and each rating level Lv of the rating table RT set by the user.

The receiving system of an embodiment can store a plurality of rating tables and have the function of editing the rating table so that a user can set arbitrarily and have great convenience. In addition, since the receiving system according to the invention can store a plurality of rating tables and flexibly replace rating tables, it can cooperate with TV rating systems for each TV station, each country, or each region.

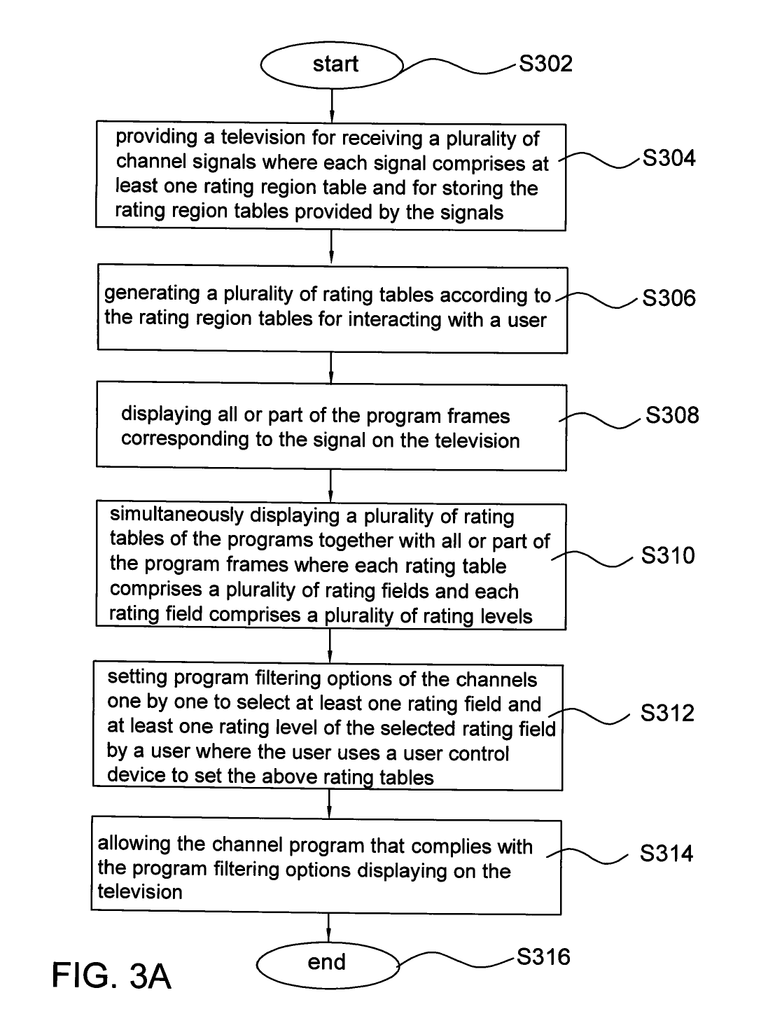

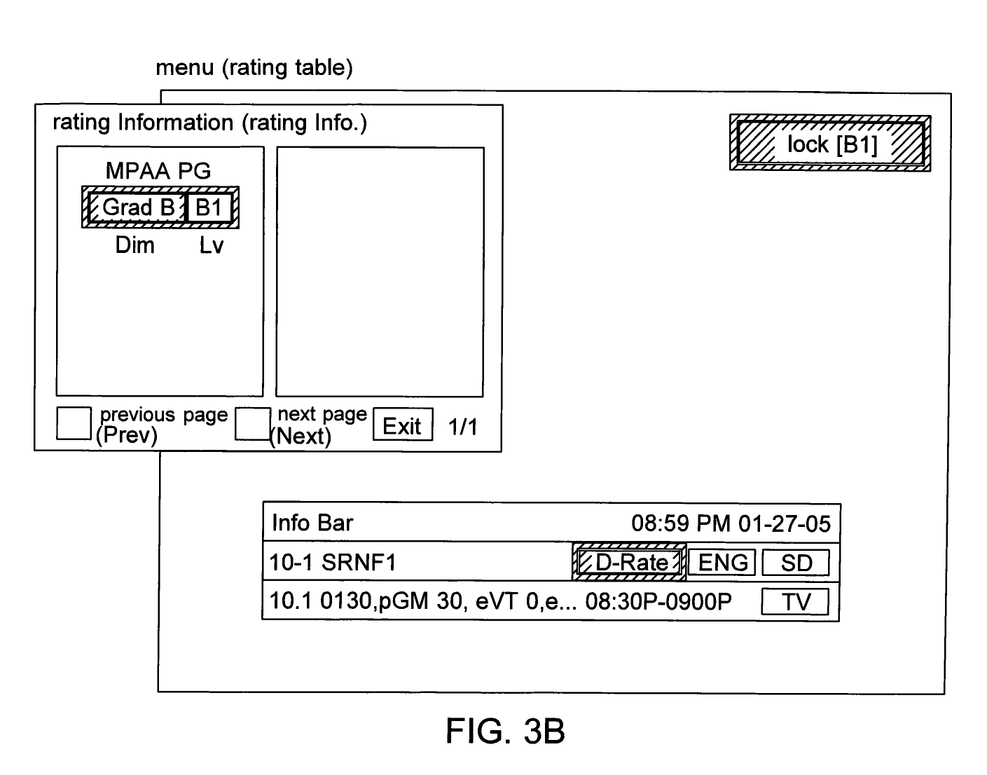

FIG. 3A shows a flow chart illustrating a setting method for filtering TV programs of an embodiment. The setting method for filtering TV programs comprises the following steps:

Step S302: start;

Step S304: providing a television for receiving a plurality of channel signals where each signal comprises at least one rating region table and for storing the rating region tables provided by the signals;

Step S306: generating a plurality of rating tables according to the rating region tables for interacting with a user (For example, the menus of the rating tables shown in FIG. 2D and FIG. 3B are user interfaces to interact with a user. In FIG. 3B, when the user selects to lock the level B1 of the field Grad B, the selecting operation can be done by a cursor and the selected position is shown by a hatched-line block, a highlight block or other way showing it is selected, such as a small window showing this field is selected. The information related to the receiving system is provided at the bottom of the figure, such as date, time, data speed, etc. for reference.);

Step S308: displaying all or part of the program frames corresponding to the signal on the television;

Step S310: simultaneously displaying a plurality of rating tables of the programs together with all or part of the program frames where each rating table comprises a plurality of rating fields and each rating field comprises a plurality of rating levels;

Step S312: setting program filtering options of the channels one by one to select at least one rating field and at least one rating level of the selected rating field by a user where the user uses a user control device to set the above rating tables (In one embodiment, the user control device can be a remote controller, mouse, keyboard, acoustic controller or the combination of the above. Obviously, the display device can be provided with a detector to detect a body motion to function as a control device. Thus, setting program filtering options can be achieved.);

Step S314: allowing the channel program that complies with the program filtering options displaying on the television;

Step S316: end.

It should be noted that, in one embodiment, the setting method for filtering TV programs further comprises blocking the channel program that does not comply with the program filtering options from being displayed on the television. Besides, the above rating table can comprise the program title, the program channel and the program can be any current or future program, such as a TV program, a promotional video clip, a prerecorded program, a video on demand program, a near video on demand program, or a paid program, etc.

It should be noted that the receiving system and related method of an embodiment use the V-Chip 2.0 standard to process the data of the downloadable rating region table DRRT, that is also compatible with the data of V-Chip 1.0. In one embodiment, as the settings for V-Chip 2.0 and V-Chip 1.0 are conflicted with each other, the setting of V-Chip 2.0 will be used first, that is, the setting of V-Chip 2.0 has higher priority.

In conclusion, as long as one common display device is provided with one single of the receiving systems of an embodiment, it is suitable for various different rating specifications. Furthermore, as the receiving system of an embodiment processes channel signals, the system does not need to repeatedly access rating tables and can accelerate its processing speed and efficiency. Therefore, the problems in the prior art can be resolved.

Those skilled in the art will readily observe that numerous modifications and alterations of the device and method may be made. Accordingly, the above disclosure should be construed as limited only by the metes and bounds of the appended claims.

What is claimed is:

1. A receiving system having sifting functions, the receiving system comprising:
a receiving unit for receiving a first signal from a first channel and a second signal from a second channel via a transmission pathway, wherein the first signal comprises at least two items selected from the group consisting of the following: a first video/audio signal, a first rating data, and a first rating region table while the second signal comprises at least two items selected from the group consisting of the following: a second video/audio signal, a second rating data, and a second rating region table;
a processing unit for processing the first signal according to at least one of the first rating data and the first rating region table, processing the second signal according to at least one of the second rating data and the second rating region table and generating a first rating table and a second rating table corresponding to the first signal and the second signal, respectively, wherein each of the first rating table and the second rating table comprises a plurality of rating fields and each rating field comprises a plurality of rating levels;
a storing unit for storing the first rating table and the second rating table;
a user interface for providing a user to set at least one of the rating fields and at least one of the rating levels in the first rating table and the second rating table; and
a determining unit for determining whether the first video/audio signal and the second video/audio signal are displayed on a display device or not according to a channel selection signal, the first rating table, and the second rating table.

2. The system according to claim 1, wherein the transmission pathway is an optical fiber, a coaxial cable, a twisted-pair cable, or radio waves.

3. The system according to claim 1, wherein the format of the rating table complies with the standard of a preset television station, a preset region or a preset country.

4. The system according to claim 1, wherein the determining unit selects the least used rating table, the oldest rating table, or a random rating table out of the first rating table and the second rating table to determine the first signal and the second signal, as the format of the first rating table is the same as that of the second rating table.

5. The system according to claim 1, wherein the same rating fields in the first rating table and the second rating table are correlated to each other, and/or the same rating levels of the same rating fields in the first rating table and the second rating table are correlated to each other.

6. The system according to claim 1, wherein the same rating fields in the first rating table and the second rating table are not correlated, and/or the same rating levels of the same rating field in the first rating table and the second rating table are not correlated.

7. The system according to claim 1, wherein the rating levels of the rating fields have a predetermined order.

8. The system according to claim 1, wherein the user interface provides a user to edit the titles or the number of the rating fields in the first rating table and the second rating table and to edit the titles or the number of the rating levels in the first rating table and the second rating table, and/or provides a user to add or delete rating tables.

9. A user interface, comprising:
a plurality of rating tables wherein each rating table corresponds to at least one signal of a channel, each rating table comprises at least one field, and each field comprises a plurality of rating levels;
a channel program filtering rating region table for being displayed on a display device wherein the data of the channel program filtering rating region table corresponds to any rating table among the plurality of rating tables;
a channel program related information corresponding to the channel program and one of the rating tables for reference; and
a cursor being displayed together with the channel program filtering rating region table on the display device to execute the operation of the rating table set by a user for selectively choosing any of the rating tables, the at least one field, and the at least one level.

10. The user interface according to claim 9, further comprising:
a plurality of functional options for executing predetermined functions in the channel program filtering rating region table.

11. The user interface according to claim 10, wherein the functional options comprise one option or any combination selected from the group comprising the following: “Left”, “Right”, “Up”, “Down”, “Move”, “OK”, “Manu”, “Exit”, “allow all”, “lock all”, and “delete all”.

12. The user interface according to claim 11, wherein the channel program filtering rating region table enters the corresponding preceding field of the rating table as the user selects “Left” option, and/or the channel program filtering rating region table enters the corresponding next field of the rating table as the user selects “Right” option.

13. The user interface according to claim 11, wherein the channel program filtering rating region table enters the corresponding preceding field of the rating table as the user selects “Up” option and the selected position exceeds the position of the uppermost level, and/or the channel program filtering rating region table enters the corresponding next field of the rating table as the user selects “Down” option and the selected position exceeds the position of the lowermost level.

14. The user interface according to claim 11, wherein the position selected by the cursor is shown by a hatched-line block or a highlight block, and/or the user utilizes cursor selection or functional options to add or delete one rating table.

15. The user interface according to claim 9, wherein the channel program related information comprises one item or any combination selected from the group comprising the following: date, time, and data speed.

16. A data sifting method, comprising:
receiving a first signal from a first channel and a second signal from a second channel via a transmission pathway, wherein the first signal comprises a first video/audio signal and at least one item selected from a first rating data and a first rating region table while the second signal comprises a second video/audio signal and at least one item selected from a second rating data and a second rating region table;
generating a first rating table according to at least one of the first rating data and the first rating region table, wherein the first rating table comprises a plurality of rating fields and each rating field comprises a plurality of rating levels;
generating a second rating table according to at least one of the second rating data and the second rating region table, wherein the second rating table comprises a plurality of rating fields and each rating field comprises a plurality of rating levels;
storing the first rating table and the second rating table;
providing a user with a user interface to set the rating fields and the rating levels in the first rating table and the second rating table; and
determining whether the first video/audio signal and the second video/audio signal are displayed on a display device or not according to at least two items selected from a channel selection signal, the first rating table, or the second rating table.

17. The method according to claim 16, wherein the step of determining whether the first video/audio signal and the second video/audio signal are displayed on a display device further comprises:
selecting either the first channel or the second channel to be displayed on the display device according to the channel selection signal; and
sifting the video/audio signal of the channel according to the corresponding rating table of the channel so as to determine whether to display on the display device or not.

18. The method according to claim 16, wherein the rating fields of the first rating table are used to block part of the first video/audio signal or all of the video/audio signal from being displayed on the display device, and/or the rating levels of the first rating table are used to block part of the first video/audio signal or all of the video/audio signal from being displayed on the display device.

19. The method according to claim 16, further comprising: blocking the channel program that does not comply with program sifting option from being displayed on the display device.

20. The method according to claim 16, wherein the first rating table comprises a title and a channel number of the first video/audio signal of the first channel.

21. The method according to claim 16, wherein the first video/audio signal is a TV program, a promotional video clip, a prerecorded program, a video on demand program, a near video on demand program, or a paid program.

22. The method according to claim 16, wherein the interface is one device or any combination selected from a remote controller, a mouse, a keyboard, and a acoustic controller, and/or the interface is a detector that can detect a body motion or a facial expression of a user.

23. A parental control system, comprising:
a storing unit for storing a plurality of rating tables wherein each rating table comprises at least one rating data and/or one downloadable rating region table of a channel signal, each rating table comprises a plurality of rating fields and each rating field comprises a plurality of rating levels;
a user interface for receiving the plurality of rating tables and displaying each rating table separately wherein the user interface is used to provide a user to set at least one rating field and at least one rating level of the channel; and
a control unit for receiving at least one channel signal and determining whether to display the program of the channel on a display device or not according to the rating table stored in the storing unit, the rating data of the channel signal, and the rating field and rating level of the rating table set by the user.

24. The system according to claim 23, wherein the format of the rating table is designed by a preset television station, a preset region or a preset country, and/or when the formats of the rating tables of the different channel signals are the same, the control unit uses the same rating table stored in the storing unit to determine the channel signals.

25. The system according to claim 23, wherein the user utilizes the user interface to edit the title of the rating field and the number of the rating fields of the rating table and to edit the title of the rating levels and the number of rating levels of the rating table, and/or utilizes the user interface to add or delete a rating table.
